(19) United States
(12) Patent Application Publication
(10) Pub. No.: US 2026/0163599 A1
(43) Pub. Date: Jun. 11, 2026

(54) RECEIVER CIRCUIT WITHOUT BASELINE WANDERING

(71) Applicant: Shanghai Zhaoxin Semiconductor Co., Ltd., Shanghai (CN)

(72) Inventors: Zhen MA, Beijing (CN); Xinwen MA, Beijing (CN)

(21) Appl. No.: 19/260,818

(22) Filed: Jul. 7, 2025

(30) Foreign Application Priority Data
Dec. 10, 2024 (CN) 202411814214.2

(51) Int. Cl. H04B 1/16; H04B 1/10; H04B 1/12

(52) U.S. Cl. CPC H04B 1/1607; H04B 1/1009; H04B 1/12

(57) ABSTRACT

A receiver circuit without baseline wandering is shown, in which the paired alternating (AC) coupling circuit and conductive (DC) coupling circuit are connected in parallel. The feedback voltages obtained from the DC coupling circuits are controlled to track the desired common mode voltage. In this manner, the common mode voltage between the equalization nodes is stable.

### CROSS REFERENCE TO RELATED APPLICATIONS

This Application claims priority of China Patent Application No. 202411814214.2, filed on Dec. 10, 2024, the entirety of which is incorporated by reference herein.

### BACKGROUND OF THE DISCLOSURE

### Field of the Disclosure

The disclosure relates to a receiver (RX) circuit of a high-speed serial interface.

### Description of the Related Art

The performance of a receiver (RX) circuit in a high-speed serial interface can be affected by unknown factors. The unknow factors may due to an external channel connection mechanism, a transmitter (TX) common mode voltage, and so on. Conventionally, a receiver circuit uses an alternating (AC) coupling circuit to filter out the direct-current and low-frequency components of the received signal.

FIG. 1 illustrates a conventional high-speed serial interface. The remote transmitter (TX) operates the driver 102 to transmit the transmission data (TXP, TXN) to the receiver (RX) through the transmission channel. The attenuated transmission data is received by the receiver as received data (RXINP, RXINN), and the disturbed direct-current or low-frequency components are filtered out by the AC coupling circuit 104 of the receiver circuit. A signal with a stable common mode voltage (VCOM) remains and is transferred to the subsequent equalizer for generation of equalized data (LEQP, LEQN).

The AC coupling circuit 104 shown in the figure is typically implemented by passive components such as resistors and capacitors, corresponding to a transfer function of H(s)=RCs/(1+RCs). It is a high-pass filter that effectively suppresses the low-frequency DC component (e.g., a long 0 or 1 signal) of the input signal. However, without the low-frequency DC component, a longer time may be required to reconstruct the common mode voltage (VCOM). The required reconstruction time depends on the RC time constant of the AC coupling circuit 104. In some examples, the reconstruction time is ranged from 500 ns to 1 us. Due to the long stabilization time at the startup of the receiver, the communication may be delayed. The suppression of the low-frequency components also damages the quality of the received low-frequency signal information. For example, the signal swing is reduced, and the jitter is obvious. A baseline wandering problem occurs.

### BRIEF SUMMARY OF THE DISCLOSURE

The disclosure introduces a receiver (RX) circuit of a high-speed serial interface, which properly solves the baseline wandering problem at the receiver end. The receiver circuit is an all-pass circuit that not only passes signals of the full frequency domain, but also quickly evaluates a stable common-mode voltage for the equalizer. Thus, fast signal response and reliable equalization of low-frequency signals are achieved.

A receiver circuit without baseline wandering in accordance with an exemplary embodiment of the disclosure includes a first alternating (AC) coupling circuit, a first conductive (DC) coupling circuit, a second AC coupling circuit, a second DC coupling circuit, a voltage sensor, an operational amplifier, and a reference current generation circuit. The first AC coupling circuit and the first DC coupling circuit are coupled in parallel between a first receiving node and a first equalization node. The second AC coupling circuit and the second DC coupling circuit are coupled in parallel between a second receiving node and a second equalization node. The voltage sensor generates a sensed voltage based on a first feedback voltage received from the first DC coupling circuit and a second feedback voltage received from the second DC coupling circuit. Based on the sensed voltage and a common mode voltage for reference, the operational amplifier controls the reference current generation circuit to generate a first bias current which is injected into the first DC coupling circuit for generation of the first feedback voltage, and controls the reference current generation circuit to generate a second bias current which is injected into the second DC coupling circuit for generation of the second feedback voltage. A low-pass path is allowed in the design of such a feedback control loop. A receiver circuit operating with a stable common-mode voltage and without baseline wandering is introduced.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 illustrates a conventional high-speed serial interface;

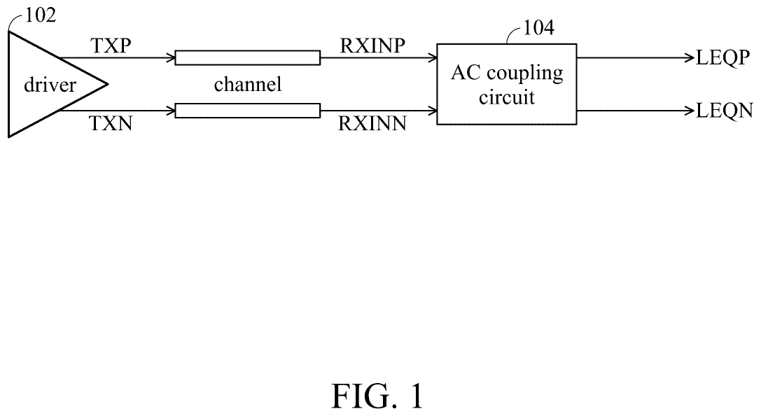

FIG. 2 illustrates a receiver (RX) circuit 200 in accordance with an exemplary embodiment of the disclosure;

FIG. 3 illustrates the details of an AC coupling circuit and a DC coupling circuit in accordance with an exemplary embodiment of the disclosure. ;

FIG. 4 illustrates details of the operational amplifier OP and the reference current generation circuit bias_gen in accordance with an exemplary embodiment of the disclosure;

FIG. 5 illustrates a passive equalizer PEQ in accordance with an exemplary embodiment of the disclosure;

FIG. 6 illustrates transfer functions, to show the improvement due to the passive equalizer PEQ; and

FIG. 7 illustrates how to design the voltage sensor V_to_V based on the passive equalizer PEQ in accordance with an exemplary embodiment of the disclosure.

### DETAILED DESCRIPTION OF THE DISCLOSURE

The following description shows various exemplary embodiments of the present disclosure, but is not intended to limit the content of the present disclosure. The actual scope of the disclosure should be defined in accordance with the appended claims. The connections between the circuits described below may be direct connections as shown in the drawings, or indirect connections through other elements. The various units, modules, or functional blocks described below may be implemented by a combination of hardware, software, and firmware, and may also include special circuits. The presented circuits, units, modules, or functional blocks are not limited to being implemented separately, but may be combined together to share certain structures.

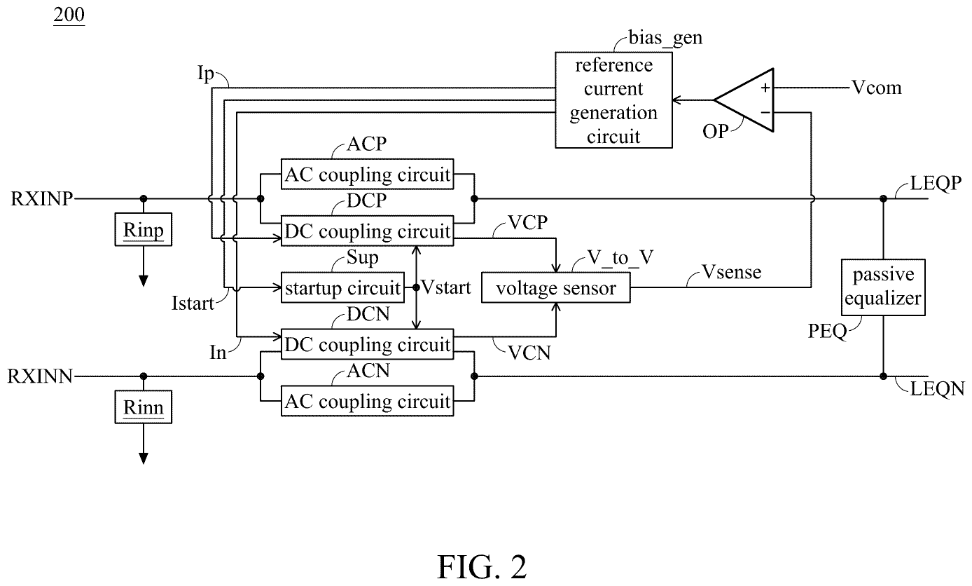

FIG. 2 illustrates a receiver (RX) circuit 200 in accordance with an exemplary embodiment of the disclosure, which includes alternating (AC) coupling circuits ACp and ACn, and conductive (DC) coupling circuits DCp and DCn, where symbols ‘p’ and ‘n’ represent the positive and negative paths of the differential structure, respectively. In an exemplary embodiment, the DC coupling circuits DCp and DCn are passive resistor networks, and are combined with the AC coupling circuits ACp and ACn to form an all-pass filter. The low-frequency and DC components of the received data (RXINP, RXINN) are presented in the equalized data (LEQP, LEQN) without distortion. In this way, the problem of baseline wandering is solved and the receiver is stabilized quickly.

Since the DC coupling circuits DCp and DCn may directly transfer the common-mode voltage of the received data (RXINP, RXINN) to the subsequent stage, unknown factors (e.g., due to the external channel connection mechanism or the common-mode voltage of the transmitter TX) may be introduced into the subsequent stage. An active equalizer may be affected by these unknow factors. The solutions to deal with these unknow factors are also introduced in this disclosure.

As shown, the receiver circuit 200 uses an operational amplifier OP, a reference current generation circuit bias_gen, and a voltage sensor V_to_V to improve the stability of a common-mode voltage. The feedback voltage VCP output from the DC coupling circuit DCp and the feedback voltage VCN output from the DC coupling circuit DCn are coupled to the voltage sensor V_to_V. The voltage sensor V_to_V outputs a sensed voltage Vsense, which is an average value of the two feedback voltages VCP and VCN. The negative input terminal ‘−’ of the operational amplifier OP receives the sensed voltage Vsense, and the positive input terminal ‘+’ of the operational amplifier OP receives desired value of a common-mode voltage VCOM. The common-mode voltage VCOM coupled to the ‘+’ terminal of the operational amplifier OP for reference use may be generated by a voltage regulator (not shown) or provided by any stable voltage source, and its value is the desired common-mode voltage for operating the subsequent circuits coupled to the receiver circuit 200. As being clamped by the operational amplifier OP, the sensed voltage Vsense tracks the common-mode voltage VCOM, and the output voltage of the operational amplifier OP is coupled to the reference current generation circuit bias_gen to generate two bias currents Ip and In. The two bias currents Ip and In are respectively injected into the DC coupling circuits DCp and DCn, and then flow to the input resistors Rinp and Rin of the receiver circuit 200. In an exemplary embodiment, the DC coupling circuits DCp and DCn each have an internal reference resistor (Rcmp and Rcmn shown in the subsequent figure). The DC coupling circuit DCp uses the voltage difference across its internal reference resistor (Rcmp) and the input terminal resistor Rinp as the feedback voltage VCP. The DC coupling circuit DCn uses the voltage difference across its internal reference resistor (Rcmn) and the input terminal resistor Rinn as the feedback voltage VCN. Through the proposed feedback control loop using the operational amplifier OP, the sensed voltage Vsense (which is a combination of the feedback voltages VCP and VCN) tracks the desired common-mode voltage VCOM. Thus, signals operate at their stable common-mode point.

For high-speed response, the receiver circuit 200 includes a startup circuit, Sup. In an exemplary embodiment, the startup circuit Sup includes a startup capacitor. The reference current generation circuit bias_gen generates a startup current Istart to charge the startup capacitor. Accordingly, the startup circuit Sup converts the startup current Istart into a startup voltage Vstart which is used in quickly start the function of the DC coupling circuits DCp and DCn. The startup circuit Sup may generate the startup voltage Vstart in a pulse form when the receiver circuit 200 starts up.

In addition, considering such an all-pass structure, the receiver circuit 200 may specially uses a passive equalizer PEQ to equalize the channel difference for the low-band signals.

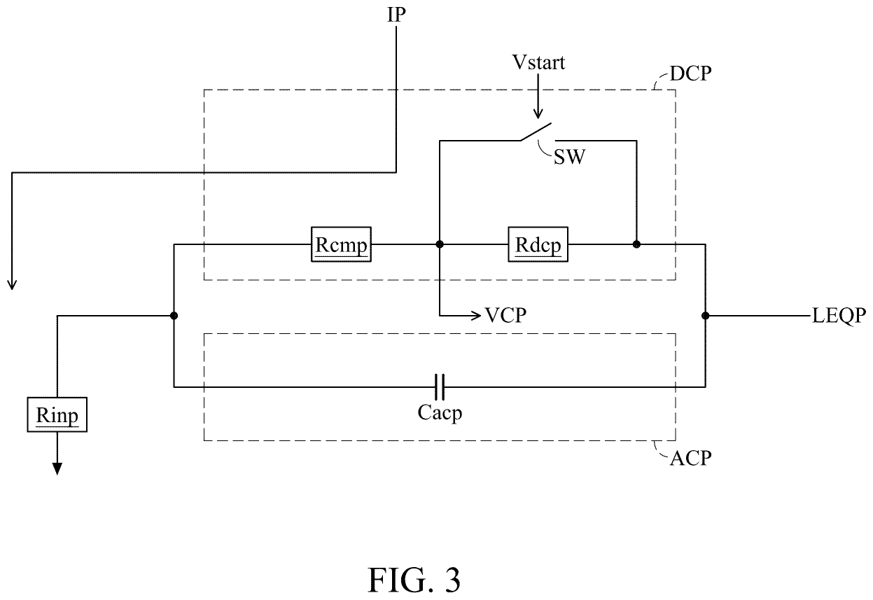

FIG. 3 illustrates the details of an AC coupling circuit and a DC coupling circuit in accordance with an exemplary embodiment of the disclosure. The differential positive channel (labeled p) is presented in FIG. 3 as an example. The differential negative channel (labeled n) can also be implemented in the similar way.

The DC coupling circuit DCp realizes DC coupling by a front-portion resistor Rcmp and a rear-portion resistor Rdcp, which are coupled in series between a receiving node (same as the data label RXINP) and an equalization node (same as the data label LEQP). The DC coupling circuit DCp further has a switch SW between the two ends of the rear-portion resistor Rdcp. The switch SW is controlled by the startup voltage Vstart. When the receiver circuit 200 is enabled, a pulse is generated as the startup voltage Vstart to close the switch SW and thereby accelerate the feedback control loop. After the startup procedure, the short circuit formed by the switch SW is no longer required, and the switch SW is open.

The AC coupling circuit ACp includes an AC coupling capacitor Cac connected in parallel with the resistors (Rcmp and Rdcp) of the DC coupling path, to achieve the full-pass filtering and thereby to get the signals of all bands.

The bias current Ip is introduced into the input resistor Rinp via the front-portion resistor Rcmp, and so that a voltage difference across the resistors Rcmp and Rinp is output by the DC coupling circuit DCp as the feedback voltage VCP, and is coupled to the voltage sensor V_to_V. As shown, VCP=Ip×(Rcmp+Rinp). In an exemplary embodiment, the resistance value of the front-portion resistor Rcmp is specially designed to make sure that the feedback voltage VCP approaches the reference common-mode voltage VCOM, and then is used as feedback information to operate the OP feedback loop of FIG. 2.

The details of the operation of the startup circuit Sup are described in this paragraph. When the receiver circuit 200 starts up, the reference current generation circuit bias_gen of FIG. 2 generates a startup current Istart, whose value is smaller than the bias current Ip (or In). The startup current Istart is used to charge the startup capacitor in the startup circuit Sup, to generate a startup voltage Vstart to turn on the voltage-controlled switch SW shown in the DC coupling circuit DCp of FIG. 3. The low impedance of the closed switch SW reduces the time constant (RC) of the filter, and the feedback control loop responds quickly. After the startup procedure, the startup circuit Sup pulls down the startup voltage Vstart, and the switch SW is open. Accordingly, the time constant (RC) of the filter is restored, and the circuit works normally.

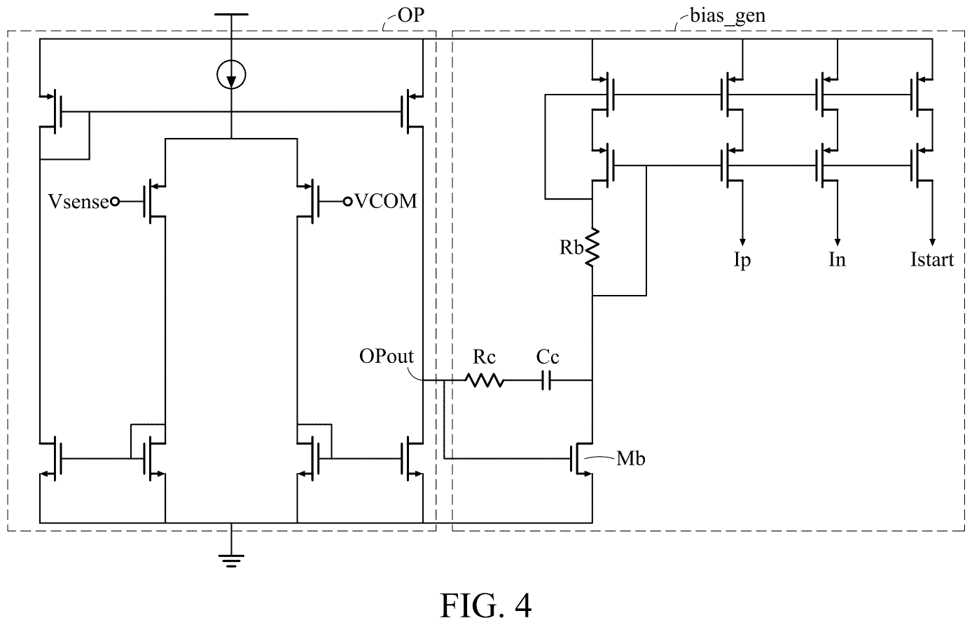

FIG. 4 illustrates details of the operational amplifier OP and the reference current generation circuit bias_gen in accordance with an exemplary embodiment of the disclosure. The reference current generation circuit bias_gen uses a common-source and common-gate current mirror technology to generate the bias currents (Ip and In) and the startup current Istart in the different paths. A common-source and common-gate current mirror is biased by a bias resistor Rb. The drain of a bias transistor Mb is not only coupled to the bias resistor Rb, but also connected to the output terminal OPout of the operational amplifier OP through a compensation capacitor Cc and a compensation resistor Rc which are connected in series. The gate of the bias transistor Mb is also controlled by the output terminal OPout of the operational amplifier OP.

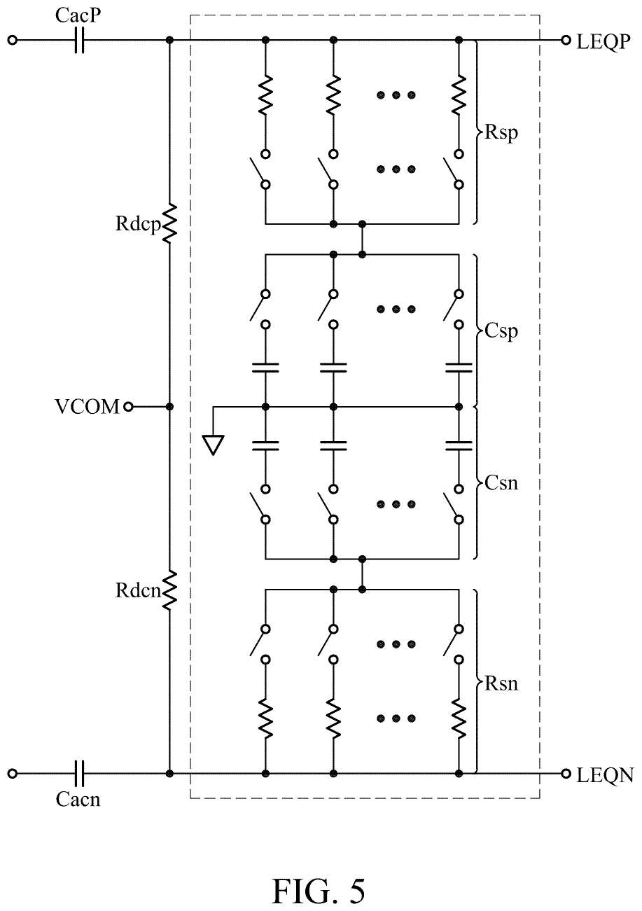

FIG. 5 illustrates a passive equalizer PEQ in accordance with an exemplary embodiment of the disclosure, which is connected between the equalization nodes LEQP and LEQN. As shown in the figure, the passive equalizer PEQ uses passive components, which are combined with the AC coupling capacitors Cacp and Cacn of the AC coupling circuits ACp and ACn to form low-frequency zeros and poles to compensate for the low-frequency attenuation due to the channel transfer. Thus, low-frequency equalization (LFEQ for short) is achieved.

The illustrated passive equalizer PEQ uses two arrays of capacitance components to provide the adjustable equalization capacitors Csp and Csn, and uses two arrays of resistance components to provide the adjustable equalization resistors Rsp and Rsn. The equalization gain, therefore is adjustable. The equalization resistor Rsp and the equalization capacitor Csp are coupled in series between the equalization node LEQP and a ground terminal. The equalization resistor Rsn and the equalization capacitor Csn are coupled in series between the equalization node LEQN and the ground.

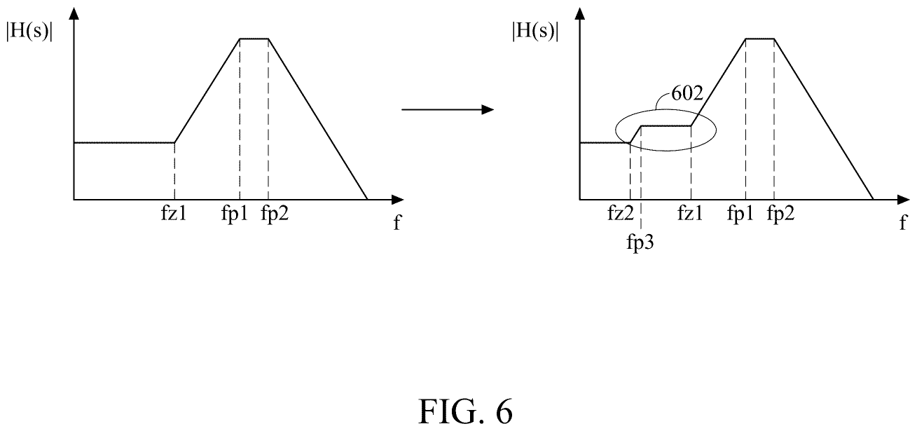

FIG. 6 illustrates transfer functions, to show the improvement due to the passive equalizer PEQ. The left figure shows the transfer function of a receiver circuit without using the passive equalizer PEQ, and the right figure shows the transfer function of a receiver circuit using the passive equalizer PEQ. The horizontal axis shows the frequency f, and the vertical axis, |H(s)|, shows the magnitude of the transfer function. In addition to the conventional zero at frequency fz1 and poles at frequencies fp1 and fp2, the passive equalizer PEQ further introduces one additional zero at the low frequency fz2 and one additional pole at the low frequency fp3. As indicated by the circle 602, an adjustable equalization gain controlled by the adjustable equalization capacitors (Csp and Csn) and the adjustable equalization resistors (Rsp and Rsn) is introduced.

In addition, the low-frequency equalization (LFEQ) brought by the passive equalizer PEQ may cooperate with a continuous time linear equalizer (CTLE) to greatly improve the equalization of mid-and high-band signals at the receiver end (RX).

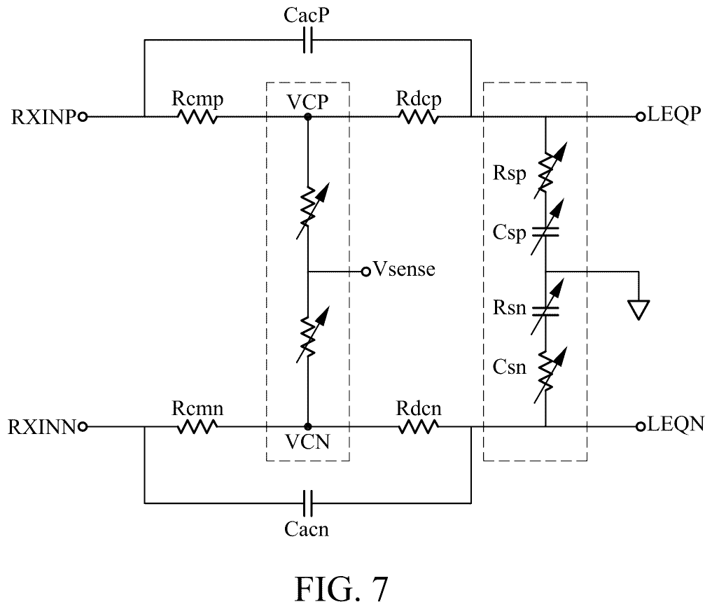

The design of the voltage sensor V_to_V may depend on the passive equalizer PEQ. FIG. 7 illustrates how to design the voltage sensor V_to_V based on the passive equalizer PEQ in accordance with an exemplary embodiment of the disclosure. The voltage sensor V_to_V is composed of two variable sensing resistors Rssp and Rssn which are connected in series between two feedback nodes (also labeled VCP and VCN). The sensed voltage Vsense is retrieved from the connection node between the variable sensing resistors Rssp and Rssn. The resistance (Rss) of the each of the variable sensing resistors Rssp and Rssn depends on the gain of the passive equalizer PEQ. The passive equalizer PEQ determines the high-frequency gain, so that the voltage sensor V_to_V determining the low-frequency gain is designed to be adaptive to the high-frequency gain. The high-and low-frequency gains are adjusted together. In an exemplary embodiment, Rss/(Rcm+Rss)=Cac/(Cac+Cs). Rcm is the resistance of each of front-portion resistors Rcmp and Rcmn. Cac is the capacitance of each of the AC coupling capacitors Cacp and Cacn. Cs is the capacitance of each of the equalization capacitors Csp and Csn.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A receiver circuit without baseline wandering, comprising:
a first alternating coupling circuit and a first conductive coupling circuit, coupled in parallel between a first receiving node and a first equalization node;
a second alternating coupling circuit and a second conductive coupling circuit, coupled in parallel between a second receiving node and a second equalization node;
a voltage sensor, generating a sensed voltage based on a first feedback voltage received from the first conductive coupling circuit and a second feedback voltage received from the second conductive coupling circuit; and
an operational amplifier and a reference current generation circuit, wherein,
based on the sensed voltage and a common mode voltage for reference, the operational amplifier controls the reference current generation circuit to generate a first bias current which is injected into the first conductive coupling circuit for generation of the first feedback voltage, and controls the reference current generation circuit to generate a second bias current which is injected into the second conductive coupling circuit for generation of the second feedback voltage.

2. The receiver circuit as claimed in claim 1, wherein:
the first conductive coupling circuit includes a first front-portion resistor and a first rear-portion resistor, which are coupled in series between the first receiving node and the first equalization node, wherein the first bias current is injected into a first connection node between the first front-portion resistor and the first rear-portion resistor to generate a voltage difference across the first front-portion resistor and a first input resistor as the first feedback voltage; and
the second conductive coupling circuit includes a second front-portion resistor and a second rear-portion resistor, which are coupled in series between the second receiving node and the second equalization node, wherein the second bias current is injected into a second connection node between the second front-portion resistor and the second rear-portion resistor to generate a voltage difference across the second front-portion resistor and a second input resistor as the second feedback voltage.

3. The receiver circuit as claimed in claim 2, wherein:
the first alternating coupling circuit includes a first alternating coupling capacitor coupled between the first receiving node and the first equalization node; and
the second alternating coupling circuit includes a second alternating coupling capacitor coupled between the second receiving node and the second equalization node.

4. The receiver circuit as claimed in claim 3, wherein:
the voltage sensor includes a first sensing resistor and a second sensing resistor, which are coupled in series between the first connection node and the second connection node; and
the sensed voltage to be coupled to the operational amplifier is obtained from a third connection node between the first sensing resistor and the second sensing resistor.

5. The receiver circuit as claimed in claim 4, further comprising:
a passive equalizer, which couples the first equalization node to the second equalization node using passive components.

6. The receiver circuit as claimed in claim 5, wherein the passive equalizer includes:
a first equalization resistor and a first equalization capacitor, coupled in series between the first equalization node and a ground terminal; and
a second equalization resistor and a second equalization capacitor, coupled in series between the second equalization node and the ground terminal.

7. The receiver circuit as claimed in claim 6, wherein:
the first equalization resistor and the second equalization resistor each is implemented by an array of resistance components, and provides adjustable resistance; and
the first equalization capacitor and the second equalization capacitor each is implemented by an array of capacitance components, and provides adjustable capacitance.

8. The receiver circuit as claimed in claim 7, wherein:
the first sensing resistor and the second sensing resistor are variable resistors, which are adjusted with the adjustable capacitance of the first equalization capacitor and the second equalization capacitor.

9. The receiver circuit as claimed in claim 8, wherein:
the first sensing resistor and the second sensing resistor is adjusted according to a formula,
$$Rss / ( Rcm + Rss ) = Cac / ( Cac + Cs ) ,$$
where:
Rss is resistance of each of the first sensing resistor and the second sensing resistor;
Rcm is resistance of each of the first front-portion resistor and the second front-portion resistor;
Cac is capacitance of each of the first alternating coupling capacitor and the second alternating coupling capacitor; and
Cs is capacitance of each of the first equalization capacitor and the second equalization capacitor.

10. The receiver circuit as claimed in claim 3, wherein the first conductive coupling circuit comprises:
a first switch, operative to short two ends of the first rear-portion resistor; and
a second switch, operative to short two ends of the second rear-portion resistor,
wherein the first switch and the second switch are closed in a pulse when the receiver circuit starts up.

11. The receiver circuit as claimed in claim 10, further comprising:
a startup circuit, providing a pulse signal to close the first switch and the second switch when the receiver circuit starts up.

12. The receiver circuit as claimed in claim 11, wherein:
the reference current generation circuit operated by the operational amplifier further generates a startup current to charge a startup capacitor in the startup circuit, to make the startup circuit provide a startup voltage to close the first switch and the second switch, wherein the startup circuit is disabled after the startup voltage is pulsed up.

13. The receiver circuit as claimed in claim 1, wherein:
the reference current generation circuit includes a common-source and common-gate current mirror which is biased by a bias resistor to generate the first bias current and the second bias current.

14. The receiver circuit as claimed in claim 13, wherein:
the reference current generation circuit includes a bias transistor, a compensation capacitor, and a compensation resistor, wherein the compensation capacitor and the compensation resistor are connected in series;
a drain of the bias transistor is coupled to an output terminal of the operational amplifier via the compensation capacitor and the compensation resistor;
a gate of the bias transistor is coupled to the output terminal of the operational amplifier; and
the bias resistor is coupled to the drain of the bias transistor.
